(19) United States
(12) Patent Application Publication
(10) Pub. No.: US 2009/0160270 A1
(43) Pub. Date: Jun. 25, 2009

(54) ELECTRIC MOTOR FOR DENTAL OR MEDICAL INSTRUMENT

(75) Inventors: Thomas Bischof, Illerbeuren (DE); Karl Mack, Luetkirch (DE)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: SycoTec GmbH & Co. KG, Leutkirch im Allgau (DE)

(21) Appl. No.: 12/339,947

(22) Filed: Dec. 19, 2008

(30) Foreign Application Priority Data
Dec. 20, 2007 (EP) EP 07076113.5

(51) Int. Cl. H02K 9/00; A61C 1/05

(52) U.S. Cl. 310/52; 433/132

(57) ABSTRACT

The present invention relates to an electric motor for the drive of a dental or medical instrument, with a rotor magnet mounted on a shaft, as well as with a stator and media conduits for leading through media to the dental instrument. A Gramme stator winding is provided in the electric motor, wherein at least regionally, media conduits run within the stator winding or between individual sections of the stator winding. The electric motor according to the invention is distinguished by a very compact constructional manner, by which the operator may work without getting tired, even over a long period of time.

### CROSS-REFERENCE TO RELATED APPLICATIONS

This application is related to co-pending and commonly assigned U.S. application Ser. No. ______ entitled “FLEXIBLE-TUBING MOTOR,” which claims the benefit under 35 U.S.C. § 119 of European Patent Application No. 07 076 114.3, filed Dec. 20, 2007. Each of the foregoing U.S. and European patent applications is incorporated herein by reference in its entirety.

This application claims the benefit under 35 U.S.C. § 119 of European Patent Application No. 07 076 113.5, filed Dec. 20, 2007, which is incorporated herein by reference in its entirety.

### TECHNICAL FIELD

The present invention relates to electric motors for the drive of dental instruments.

### BACKGROUND

Dental drive systems usually comprise a dental instrument for receiving a rotating tool, as well as a drive motor, which may be coupled via a quick-coupling (e.g. a coupling according to DIN ISO 3964), to the instrument. The motor in turn is preferably connected via a further quick-coupling to a flexible supply tubing, wherein the flexible supply tubing also contains the electricity supply for the electric motor, as well as media supply conduits for water and air. These are thus usually three individual components which are insertably coupled according to the state of the art. The disadvantage of these usual arrangements is however the high weight as well as the unfavorable position of the center of gravity of the electric motor. The operator (a dentist for example or a dental technician) grips the system mostly in the region of the motor. The operator tires relatively quickly on account of the mentioned disadvantageous situation with regard to weight and the position of the center of gravity.

### SUMMARY

It is therefore the object of the present invention to provide an electric motor for the drive of a dental instrument, which is lightweight and is compact, in order thus to ensure a simplified operation by the dentist or a dental technician, also over a long period of time.

This object is achieved by an electric motor according to claim 1.

According to the invention, hereby an electric motor is provided for the drive of the dental instrument, with a rotor magnet mounted on a shaft, a stator, as well as media conduits for supplying media to the dental instrument. A Gramme stator winding is hereby provided, wherein media conduits run at least in regions within this stator winding or between individual sections. “Within this stator winding” is to be understood in that the media conduits lie radially within the largest outer diameter of the winding, and radially outside the smallest diameter. With shapes which are not circular, in each case the smallest circumscribing circle is to be assumed for the diameter.

“Dental instrument” is to be understood in particular to include a dental, orthodontic or dental-technical hand-piece and angle-piece.

“Gramme stator winding” in the context of this application, is to be understood in that the stator comprises a yoke winding or a ring winding according to Gramme. The advantage of this technology lies in the fact that the conductors run essentially in the axial direction in the magnetically active region, which faces the permanent-magnetic rotor magnet, as well as in the passive region at the back of the stator. In this way, according to the invention, it is possible to lead the media in the diameter region of the winding on the inside between the rotor and the stator yoke, as well on the outside in the region of the leading-back of the winding. Ideally, this is effected between the individual sections of the stator winding mentioned above.

In other words, the winding wires with this winding, are wound around the preferably annular stator core and hereby (at least on the radial inner side as well as radial outer side of the stator core) are essentially parallel to the shaft. According to the invention, hereby, an angular deviation is however possible.

With the inventive leading of media conduits through the stator (and hereby possibly also in the region encompassed by the stator yoke), the stator is rendered fully usable for media passages with electric motors for the drive of dental instruments.

This for starters, leads to the extent of the motor or of the hand apparatus, which accommodates the dental instrument, being able to be kept small in the radial direction.

A further great advantage is the fact that the electric motor (i.e. the stator magnet as well as the rotor magnet) may be kept very short in the direction of the rotor/the rotor shaft, on account of the stator winding according to the invention.

In this way, according to the invention, the constructional size is reduced in the longitudinal direction as well as in the radial direction, and the advantages of operation without tiring result for the operator.

Advantageous further formations are described in the dependent claims.

The motor according to the invention is advantageously designed as a permanent magnet synchronous motor or as a d.c. motor without collector (BDLC-motor). By way of this, a relatively wear-free arrangement results, in particular with the high rotational speed applications which are required in the dental field.

The sections of the stator winding in each case advantageously represent individual coils. Hereby, in each case, diametrically opposite individual coils may be connected to one another in each case into a coil pair, and be switched to a phase. A relatively good efficiency with a compact construction manner and a low wear, results by way of this, with still acceptable construction costs.

The individual coils or the individual sections may hereby preferably be wound in a multi-layered manner. The individual coils or sections themselves may preferably not be arranged in an overlapping manner, in order in particular to save radial construction space.

The stator may preferably comprise a yoke ring, wherein this yoke ring may be preferably enclosed by a coil body of the stator. The manufacturing costs are minimized by way of this multi-part modular constructional shape, and coil bodies of different types may be applied, which are adapted to the respective media conduits, i.e. to their size or course.

The stator winding hereby is wound around sections of the yoke ring or coil body, which are essentially shaped in the manner of an annulus segment. The yoke ring in turn is constructed in the context of an inexpensive and modular construction of several layers of a sheet-metal. Preferably, the stator winding may be filled out or cast out with a resin material or with a plastic material.

It is very advantageous for the electric motor according to the invention, despite its very small constructional size, to comprise a coupling, which is common in practice, for receiving a dental instrument to be driven, in particular a coupling according to DIN ISO 3964, which thus permits the attachment of existing and inexpensive instruments. The electric motor as such may however also be installed directly into an instrument or hand-piece and angle-piece.

The yoke ring of the electric motor may be preferably enclosed by the coil body radially to the outside or radially to the inside. Hereby, radial protuberances of the coil body may be located between the sections of the stator winding, in order to achieve a particularly well geometrically defined leading of the media conduits in this, and hereby to also obtain an acceptable temperature drop to the possibly warmer stator winding. These protuberances may e.g. be designed as annulus segment sections or as a parallelepiped. The media conduits may hereby run preferably in the longitudinal direction of the shaft through the stator or the coil body (and there e.g. through bores or grooves/channels). In particular, hereby, the heating of the media (air or water) may be neglected due to the short constructional arrangement.

However, a coil body is not necessarily to be provided.

The media conduits may preferably be media conduits for carrying water, electricity, air (in particular compressed air) or also light.

The ratio of the size extent of the stator radially to the shaft, to the greatest extent of the stator in the direction of the shaft (longitudinal direction), is preferably between 0.8 and 5, particularly preferably between 1 and 3, in a very particularly preferred embodiment is between 1.2 and 1.6.

Hereby, the extents of the stator (in the radial or axial direction) which are mentioned above are to be understood as the largest dimensions of the respective winding sections.

Preferably, the ratio of the greatest extent of the stator radially to the shaft, to the greatest length of the rotor magnet (length of the rotor magnet in the direction of the shaft) lies between 1 and 6, preferably between 1.1 and 2, particularly preferably between 1.6 and 1.8.

In this way, it is clear that the motor according to the invention may be manufactured in a very particularly short construction manner for its power class. “Greatest extent of the stator radially to the shaft” is again the largest extent of the electrically effective parts, preferably of the stator winding. “Greatest length of the rotor magnet in the shaft direction” is also only to be understood as the section with actual permanent-magnetic material, thus without connecting (for example magnetized in later operation) metal sections.

One particularly advantageous construction shape envisages the electric motor being connected to a flexible tubing without any coupling, wherein the flexible tubing at the end which is distant to the electric motor, comprises a drive and control unit for supplying and regulating media. In other words, media conduits run through the flexible tubing, which then run without coupling to the coupling for the dental instrument, and therefore one may make do without at least one coupling, which usually lies between the flexible tubing piece and the motor which is to be connected to this by way of a coupling.

In a particularly preferable embodiment, a fiber-optic (media conduit for leading light) may yet run through the flexible tubing. This permits a light source to be arranged in the drive and control unit, and this light is then led through the flexible tubing and the motor towards the dental instrument. In this way, the flexible-tubing motor according to the invention may be constructed even smaller, since for example no light source needs to be attached in the region of the motor. Moreover, the advantage results, that the operator is not unpleasantly influenced by the heating caused by the light source. Finally, with the coupling-free flexible-tubing motor it is particularly advantageous that no coupling is provided at the transition from the flexible tubing to the motor, said coupling leading to a loss of brightness due to scatter light in the case of a fiber optic.

The flexible tubing according to the invention may be designed practically infinitely long, the greatest length of the flexible-tubing motor (thus flexible tubing including electric motor from the tip of the coupling to the dental instrument, up to the run-out of the flexible tubing into the drive and control unit) may be between 1 m and 3 m without further ado. Further advantageous formations of the invention are specified in the remaining claims.

### BRIEF DESCRIPTION OF THE DRAWINGS

The invention is now explained by way of several figures. There are shown in:

FIG. 1 is a view of an electric motor according to the invention, which on the left comprises a coupling for attaching a dental instrument.

FIG. 2 is a view which is partly sectioned away, of the stator according to the invention.

FIGS. 3a to 3c are various views of a flexible-tubing motor according to the invention.

FIG. 4 is a representation of an electric motor integrated into the instrument.

FIG. 5 is a representation of a dental system, according to the state of the art.

### DETAILED DESCRIPTION

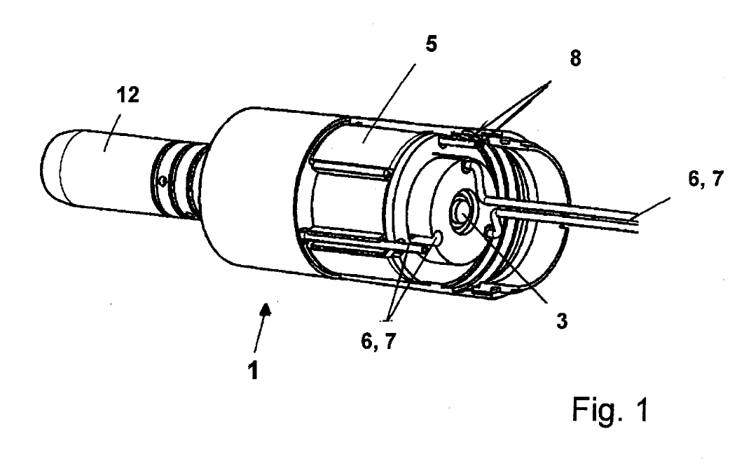

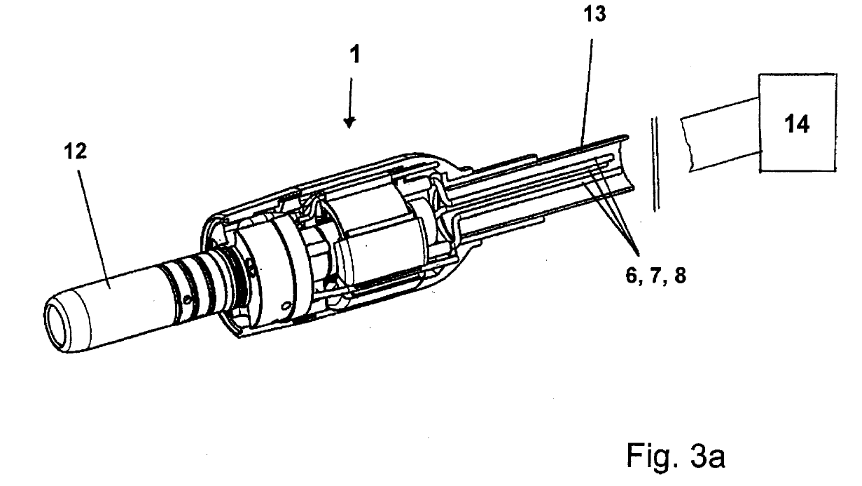

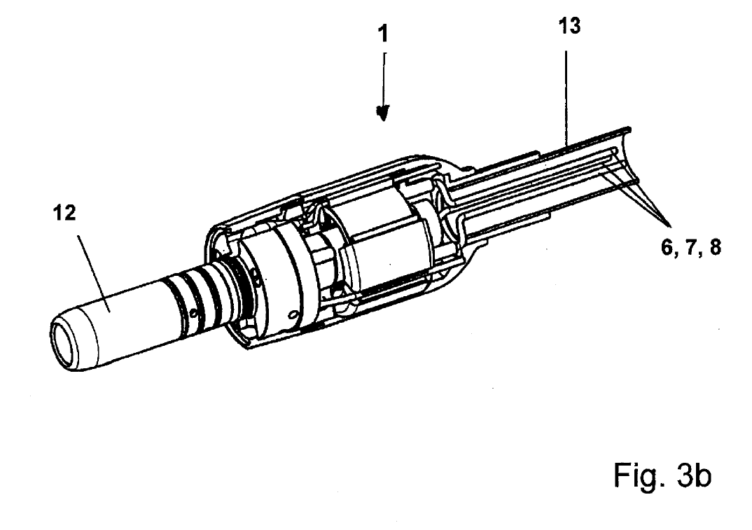

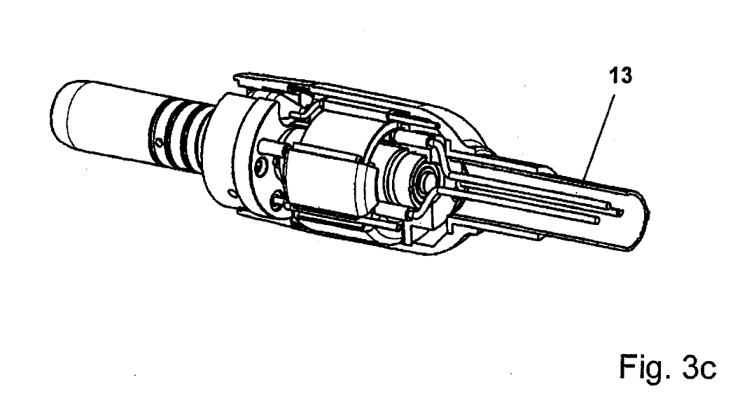

FIG. 1 shows an electric motor 1 according to the invention. This is accommodated in a housing, to which a coupling 12 according to DIN ISO 3964, for the connection of dental instruments, is attached. The electric motor 1 itself comprises a shaft 3 which is connected to a rotor magnet 4. A stator 5 is concentrically arranged around this, and media conduits 6 and 7 (for water and air) and light (media conduit 8) run through the stator, i.e. they no longer need to be led outside the stator. The “media conduit for light” may either be a fiber optic (e.g. glass fiber), alternatively also an electricity supply, to a light or light diode which is introduced in the region of the coupling to the dental instrument. “Through the stator” or “within the stator” hereby it to be understood in that the media conduits run radially within electrically effective regions of the stator, here radially within the largest dimensions of the stator windings. The media conduits or electrical supply leads for the motor according to the invention run through a flexible tubing which is no longer shown on the right in FIG. 1, which may either be firmly connected to the electric motor or may be coupled to this via the coupling. The media conduits hereby project preferably radially inwards (see FIG. 3) on the side which is distant to the coupling 12, in order in this region to provide a flexible tubing with a small diameter as soon as possible after the end of the electric motor.

The electric motor 1 is a permanent magnet synchronous motor, here a d.c. motor without collector (BLDC motor).

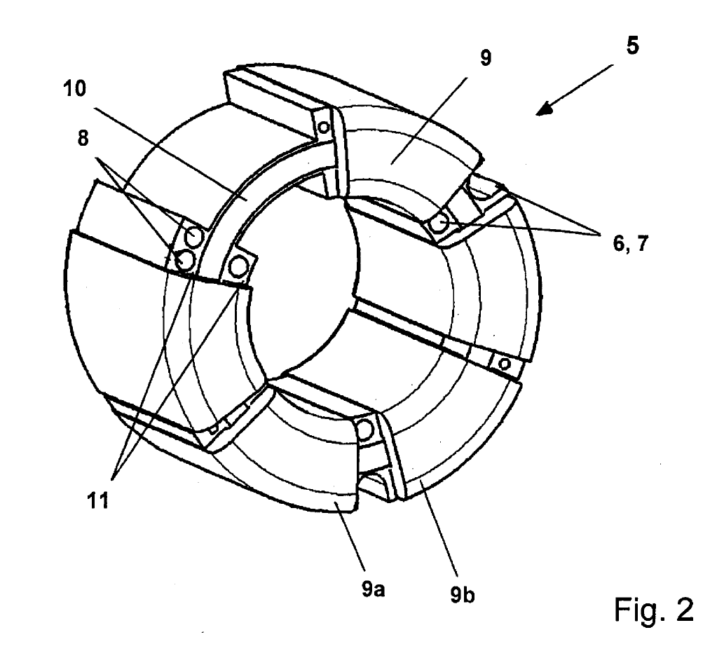

FIG. 2 shows a detailed, partly freely sectioned construction of the stator 5. This stator comprises a stator winding 9 which is wound according to Gramme, i.e. around the coil body 11 which radially encloses a yoke ring 10 belonging to the coil body. The winding wires hereby run around the outer ring formed by the coil body or around the annular stator core. In the representation shown in FIG. 2, the winding 9 hereby is subdivided into several sections, which in each case represent annulus segments. These annulus-segment-shaped sections (for example a first section 9a or a second section 9b) are preferably represented as individual coils. The winding wires of these individual coils are arranged essentially in the running direction of the shaft 3, (this runs essentially aligned to the coupling 12, see FIG. 1). The course of the winding wires along the shaft 3 hereby only applies to the radial inner side or radial outer side, and at the end-side the winding wire runs essential radially inwards or radially outwards.

In total, six individual coils 9a, 9b, etc. are provided, wherein the respective diametrically oppositely lying individual coils are connected to one another in each case into a coil pair and are switched to a phase.

The sections 9a, 9b, etc. or individual coils are wound in a multi-layered manner and do not overlap, even in their end regions. The corresponding stator winding is cast with an artificial resin or plastic.

The stator 5 shows the yoke ring 10 which is surrounded radially inwards and radially outwards by the coil body, and the coil body in turn is surrounded by the corresponding winding.

The yoke ring 10 is constructed of several layers of a sheet-metal.

The coil body between the individual sections 9a, 9b, etc. comprises radial protuberances, which run radially outwards or radially inwards (thus to the rotor magnet). In these regions, the passage of the media conduit 8 by light or the media conduit 7 by air or the media conduit 6 by water, is possible without an unnecessary field influence or thermal influence by the electric motor. Basically, one may lead through an infinite number of media conduits, possible are also electricity supply leads, in the case that the dental instrument should require additional connections here. The media conduits may thus run within or outside a yoke ring. They do not necessarily need to run between individual sections or the stator windings, but may also run through the stator winding.

The ratio of the size extent of the stator radially to the shaft (largest diameter region of the stator in FIG. 2, measured as a diagonal of the two points which are radially distanced the most, in a plane of the stator winding which is perpendicular to the shaft), to the greatest extent of the stator in the direction of the shaft (thus in the longitudinal direction of the shaft, here therefore aligned to the coupling, again here between the regions of the stator winding which are axially distanced the most from one another), is 1.4.

The ratio of the greatest extent of the stator radially to the shaft (here again the largest diameter dimension in the region of the stator winding), to the greatest length of the rotor magnet (only the length of the actual rotor magnet is considered), is 1.5.

FIGS. 3a to 3c show different views of a flexible-tubing motor according to the invention. Hereby, the electric motor 1 according to the invention, which is arranged in the housing, with which the housing on the left side comprises the coupling 12 according to DIN ISO 3964, is connected directly to a flexible tubing 13 on the right side, without yet an additional coupling being provided here. Such a coupling would entail large construction costs, further sources of errors, as well as a greater weight. The media conduits for air, water or light 6, 7, 8 hereby run through the flexible tubing 13 up to a drive and control unit 14. Here, the greatest distance measured from the tip of the coupling 12, up to the run-out of the flexible tubing 13 into the drive and control unit 14, is 2.5 m

It is to be noted that the media conduit 8 for leading through light, which is preferably designed as a glass fiber conduit (alternatively as an electricity supply lead), runs directly from the drive and control unit to the coupling 12 without interruption. A light source which feeds the light into this fiber-optic, is provided in the drive and control unit. By way of this, there is no necessity of an additional light source in the region of the electric motor 1, which would require additional construction space or would entail an increased heat dissipation in the region of the hand of the operator. In particular, by way of making do without a coupling between the electric motor and the flexible tubing, one also ensures that this coupling produces no scatter light loss.

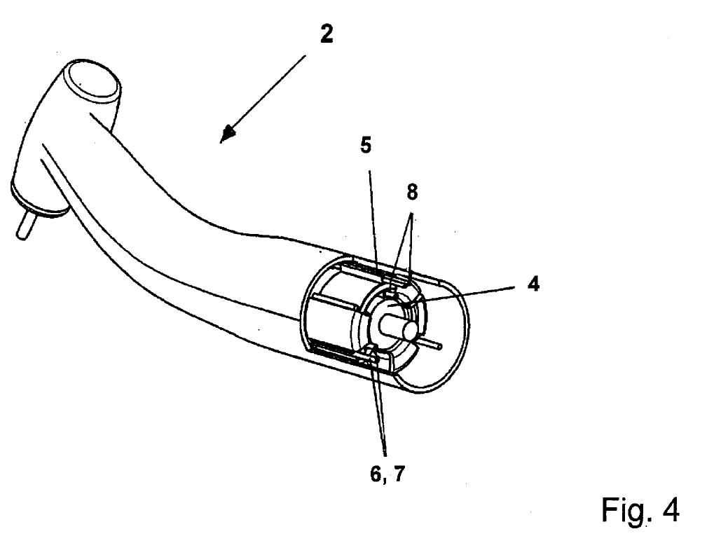

FIG. 4 shows an example of a dental instrument 2 with an integrated electric motor according to the invention. “Dental instrument” in the content of this application is to be understood to include an apparatus, which in a manner driven by motor, permits the machining of objects or teeth, preferably by a dentist, dental technician or corresponding personnel.

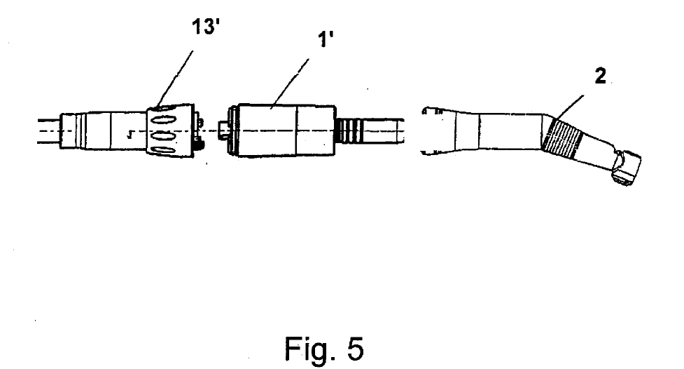

FIG. 5 shows the construction of a dental system according to the state of the art, with which a dental instrument 2 is coupled via a coupling according to DIN ISO 3964 to a motor 1′, which then in turn may be connected to a flexible tubing piece 13′ via a further coupling.

We claim:

1. An electric motor for the drive of a dental or medical instrument, the motor comprising:
a rotor magnet mounted on a shaft;
a stator comprising a Gramme stator winding including a plurality of individual stator winding sections; and
a plurality of media conduits for supplying media to the instrument, each of the media conduits disposed within the stator winding or between individual stator winding sections.

2. An electric motor according to claim 1, wherein the electric motor is a permanent magnet synchronous motor or a d.c. motor without collector.

3. An electric motor according to claim 1, wherein each of the plurality of individual stator winding sections includes an individual coil.

4. An electric motor according to claim 3, wherein the plurality of individual stator winding sections includes six individual stator winding sections each including an individual coil, the six individual stator winding sections disposed so as to define diametrically opposite individual stator winding sections, wherein the coils of respective diametrically opposite individual stator winding sections are connected to one another in each case into a coil pair, and are switched to a phase.

5. An electric motor according to claim 3, wherein the individual coils are wound in a multi-layered manner.

6. An electric motor according to claim 3, wherein the individual coils are arranged in a non-overlapping manner.

7. An electric motor according to claim 3, wherein the stator includes a yoke ring enclosed by a coil body of the stator, and wherein the individual stator winding sections are wound around essentially annulus-segment-shaped sections of the yoke ring and/or of the coil body of the stator.

8. An electric motor according to claim 7, wherein the yoke ring is constructed of several layers of sheet-metal, and wherein the stator winding is filled out with plastic.

9. An electric motor according to claim 7, further comprising a coupling for receiving the dental or medical instrument to be driven.

10. An electric motor according to claim 7, wherein the yoke ring is enclosed radially outwards and/or radially inwards by the coil body.

11. An electric motor according to claim 7, wherein the coil body includes radial protuberances located between the individual stator winding sections.

12. An electric motor according to claim 7, wherein the media conduits run essentially in a longitudinal direction of the shaft through the coil body.

13. An electric motor according to claim 12, wherein the media conduits are configured for transmitting light, water, electricity, non-compressed air, or compressed air.

14. An electric motor according to claim 1, wherein a ratio of the greatest extent of the stator radially to the shaft, to the greatest extent of the stator in the direction of the shaft, is between 0.8 and 5.

15. The electric motor according to claim 14, wherein the ratio of the greatest extent of the stator radially to the shaft, to the greatest extent of the stator in the direction of the shaft, is between 1.2 and 1.6.

16. An electric motor according to claim 1, wherein a ratio of the greatest extent of the stator radially to the shaft, to a greatest length of the rotor magnet in the shaft direction, is between 1 and 6.

17. The electric motor according to claim 16, wherein the ratio of the greatest extent of the stator radially to the shaft, to a greatest length of the rotor magnet in the shaft direction, is between 1.6 and 1.8.

18. An apparatus comprising:
an electric motor for the drive of a dental or medical instrument, the electric motor comprising:
a rotor magnet mounted on a shaft;
a stator comprising a Gramme stator winding including a plurality of individual stator winding sections; and
a plurality of media conduits for supplying media to the dental or medical instrument, each of the media conduits disposed within the stator winding between individual stator winding sections;
a flexible tubing connected to the electric motor in a coupling-free manner, wherein an end of the flexible tubing distant to the electric motor comprises a drive and control unit for supplying and regulating media.

19. The apparatus of claim 18, wherein the plurality of media conduits includes a media conduit for light running through the electric motor and the flexible tubing, wherein a light source is provided in the drive and control unit.

20. The apparatus of claim 18, further comprising a coupling connected to the electric motor opposite the flexible tubing for coupling dental instruments to the electric motor, wherein a maximum combined length of the coupling, the electric motor, and the flexible tubing up to a beginning of the drive and control unit is between 1 m and 3 m.
